(19) United States
(12) Patent Application Publication
(10) Pub. No.: US 2007/0066165 A1
(43) Pub. Date: Mar. 22, 2007

(54) Fire protection coating for FRP-reinforced structure

(76) Inventor: Edward R. Fyfe, Del Mar, CA (US)

Correspondence Address: Mary Jo Redman, 6387 Caminito Lazaro, San Diego, CA, 92111, US

(21) Appl. No.: 10/949,059

(22) Filed: Sep. 23, 2004

Related U.S. Application Data
(63) Continuation-in-part of application No. 10/383,265, filed on Mar. 5, 2003, now abandoned.

(51) Int. Cl. B32B 5/02

(52) U.S. Cl. 442/59

(57) ABSTRACT

A fire protection coating 10 includes insulation layer 20 including at least 20% free moisture. Insulation layer 20, preferably a vermiculite/gypsum mixture 26, is applied such as by spraying a water slurry of the mineral particles to structural member 85. Before the free moisture can evaporate, diffusion barrier 40, such as artificial stone formulation 44, is applied over the moist vermiculite/gypsum mixture 26. Moisture is retained within vermiculite/gypsum mixture 26 indefinitely and is released in the event of a fire to help cool and prolong the efficacy of fire protection coating 10.

### CROSS REFERENCE TO RELATED APPLICATIONS

This application is a Continuation-in-Part of application Ser. No. 10/383,265, filed Mar. 5, 2003.

### FIELD OF THE INVENTION

This invention relates to fire protection of structures, and more specifically to fire protection coating applied to structural members of a finished building reinforced with fiber/resin composite materials.

### BACKGROUND OF THE INVENTION

In large structures, including bridges, tunnels, and buildings, the load-bearing structural members are generally of concrete or steel. Concrete is usually considered inherently fire-resistant because it is non-combustible. Steel is also non-combustible, but high temperature from a fire weakens steel greatly and can cause it to fail. For this reason, steel is required to be “fire-proofed” when used in a large structure. Some concrete structures, such as tunnels, also require fire-proofing.

Many concrete structures have had reinforcement layers added to them to improve their resistance to shear forces, such as from earthquakes, catastrophic winds, or explosions. Some methods of reinforcement of structures are disclosed in U.S. Pat. Nos. 6,138,420, 5,657,595, 5,649,398, and 5,043,033. The reinforcement layers typically include a fiber/resin composite, such a glass or carbon fiber textile embedded in a matrix of epoxy or polyurethane resin. Such materials are more combustible than concrete and decrease the overall strength of the structure in a fire.

One of the stated advantages of using these composite materials for reinforcement of existing structures is that they are pliable and thin, thus can be installed into narrow crevices and onto complex shapes. They can be applied to historical structures without unduly changing the shape of structural members or obscuring surface details.

If the surface texture, detailed shape, or absolute dimensions of a structure are not important, such as of a freeway overpass, seismic or other reinforcement may be added by spraying a thick cementitious layer over the structure. Such a cementitious coating does not add to the need for fire protection.

An accepted method of fire-proofing fire-susceptible structural members is to coat them with insulation material, such as by spraying on a slurry of insulative particles suspended in water. Such coatings are sometimes called Spray Applied Fire Resistive Materials (SFRMs). Many sorts of insulating materials including mineral, cellulosic, and synthetic, are in use. Vermiculite, perlite, and gypsum are examples of mineral insulation materials that are commercially supplied for spray application. Coconut husk fiber and shredded paper are examples of cellulosic material. Other fibers that are sometimes added include glass, carbon, and polyester. To bind the particles together after the water evaporates, an alumino-silicate “geopolymer” binder is sometimes included in the slurry.

Minerals such as vermiculite, perlite, and gypsum provide thermal insulation of the underlying structural member and greatly slow the temperature rise of the steel or wood. Slowing the temperature rise provides time for the fire to be extinguished before the structural member fails.

A sprayed-on insulative mineral slurry, used alone, typically is 0.5 to 4 inches thick, depending on the hours of protection specified by a designer or by a fire code.

Another type of fire protection coating is “intumescent coating,” which is a paint-like coating that foams and chars when exposed to high temperature. The coating's thickness may increase by a factor of 15 to 100 by creation of a spongy structure that provides thermal insulation. The charred surface resists combustion and may ablate during the course of a fire. Intumescent coatings may be applied as thick as 0.5 inch.

Insulative and intumescent coatings are both effective forms of fire protection, but each has certain drawbacks. Insulative coatings give protection that is a function of their density and thickness. In some cases, achieving the required fire rating would require a greater thickness of insulative coating than can physically be applied. In such a case, the insulative coating must be combined with another type of coating that functions in a different manner.

Intumescent materials are fairly expensive, so designs that require a thick coating of intumescent coating are expensive to build. Also, because part of the protection provided by an intumescent coating comes from the charring and ablation, not all shapes are protected equally well by a given thickness of intumescent. On cylindrical columns or pillars, for example, the char may detach prematurely as compared to on a flat surface, thus decreasing the protection time of the coating. Because of this shape sensitivity, intumescent coatings may be applied over-thickly, to “be on the safe side” of the design, increasing the cost even more. Intumescent paint generates smoke under some fire conditions, which is undesirable and may cause failure of a fire resistance rating test.

Thus, there is a need for effective fire protection with thinner layers of coating than conventionally used, for both cost and design reasons. Especially in the case of protecting fiber/resin composite reinforced structures from fire, there is a critical need to decrease the thickness of insulation required. Because fiber/resin composites are typically used on structures where there is a requirement for thin, conformal reinforcement means, it follows that any additional fire protection coating should also be as thin and conformal to the contours of the structure as possible. There is also a need for an efficient fire protection coating that does not generate smoke.

### SUMMARY OF THE INVENTION

This invention is a method of applying a fire protective coating to a structure, including a pre-existing structure. The method is especially well-suited to fire protection of a structure that has been reinforced with fiber/resin composite materials, also known as fiber-reinforced plastic, or “FRP.” Using this method, a desired fire rating can be achieved using thinner insulation than with conventional methods of fire-proofing.

The invention is a new method of using a combination of insulative material and a non-permeable material. An insulation layer, consisting of a mineral SFRM in water suspension, is sprayed onto the structural member to be protected. Instead of allowing the water to evaporate away, leaving only mineral particles attached to the structural member, a diffusion barrier of non-permeable material is applied over the SFRM while substantial free moisture remains.

The diffusion barrier is preferably a layer of a non-combustible material, which can be applied over the insulation layer in a similar manner as paint would be. An example of a preferred material is a sprayable “artificial stone.” The diffusion barrier traps free moisture within the insulation layer indefinitely. Although conventional materials are used in the invention, the new method of applying them results in a new sort of finished fire-protection coating, one that contains substantial free moisture that becomes available when needed.

In the event of a fire, the insulation layer slows the heating of the underlying structural member. Residual moisture within the insulation layer traps heat and further delays ignition of the structural member.

Using this method and combination of materials, a fire rating of 4 hours (ASTM E119—Concrete Under Load) can be achieved with a coating thickness of only 1 inch of SFRM and 0.01 inch of diffusion barrier. This is a substantial decrease in thickness compared to conventional fire protection coatings, making it lower cost and especially valuable for use on existing structures that have been reinforced with retrofitted fiber/resin composite materials.

The invention will now be described in more particular detail with respect to the accompanying drawings in which like reference numerals refer to like parts throughout.

### BRIEF DESCRIPTION OF THE DRAWINGS

FIG. 1 is a side elevation view, partly cut away, of a steel girder with fire protection coating.

FIG. 2 is a sectional view, taken on line 2-2 of FIG. 1.

FIG. 3 is a perspective view, partly cut away, of fire protection coating over a composite panel reinforced structural member.

FIG. 4 is a perspective view, partly cut away, of fire protection coating over a beam attached to a support by a fiber/resin composite anchor.

FIG. 5 is a side section view of fire protective coating over a concrete column.

FIG. 6 is an enlarged view, partly cut away, of the column of FIG. 5.

FIG. 7 is a sectional view, partly cut away, of fire protective coating on a concrete floor deck reinforced with a composite panel.

FIG. 8 is a sectional view, partly cut away, of a concrete beam reinforced with a composite panel.

### DETAILED DESCRIPTION OF THE INVENTION

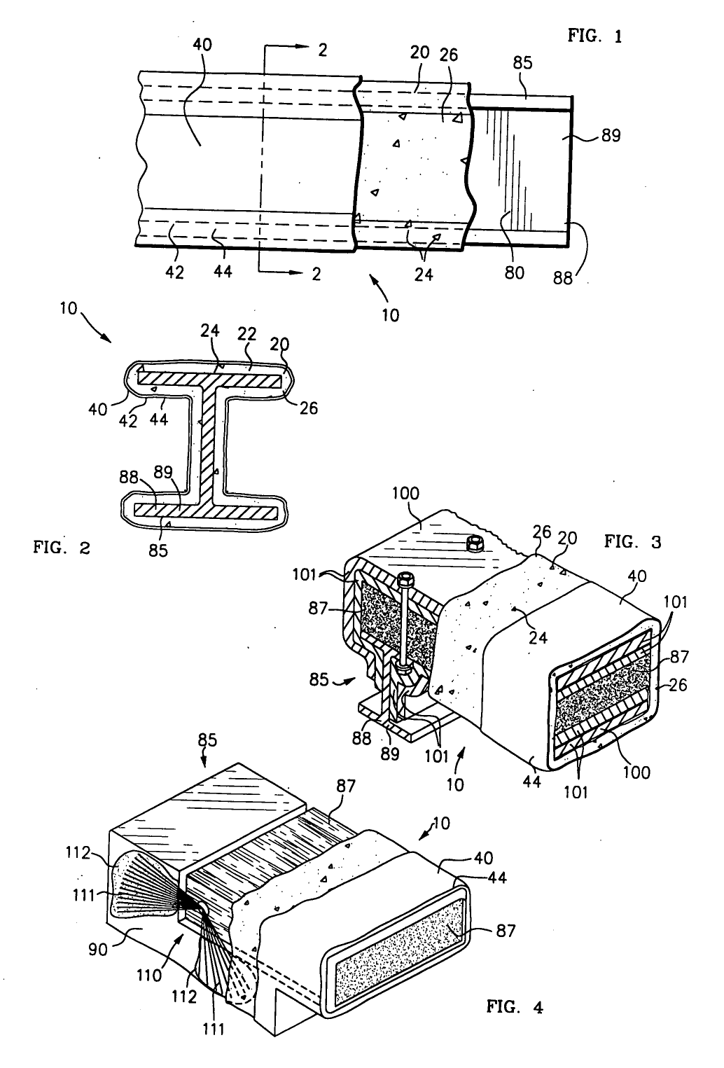

FIG. 1 is a side elevation view, partly cut away, of a steel girder 88, such as I-beam 89, with fire protection coating 10 applied according to the method of the present invention. FIG. 2 is a sectional view, taken on line 2-2 of FIG. 1. Fire protection coating 10 includes an insulation layer 20 and a diffusion barrier layer 40.

FIG. 3 is a perspective view, partly cut away, of fire protection coating 10 over a structural member 85 that includes an 1-beam 89, a beam 87, and reinforcement 100. Reinforcement 100 consists of a plurality of fiber/resin composite panels or wraps 101 wrapped upon and attached to I-beam 89 and beam 87. Panels 101 have been added to existing structural member 85 to provide additional resistance to lateral forces, such as from earthquakes, high winds, or explosions. Reinforcement 100 is typical of retrofitted fiber/resin composite seismic reinforcement to an existing structure. Composite panels 101 are typically of epoxy-impregnated fiberglass.

FIG. 4 is a perspective view, partly cut away, of fire protection coating 10 over a structural member 85 that includes a beam 87, which may be of wood, concrete, structural plastic, or other material, resting upon a support member 89, typically of concrete, and a fiber/resin composite anchor 110 that anchors beam 87 to support member 89. Anchor 110 includes a borehole 113 drilled into one member, in this case beam 87, a length of fiber roving 111 inserted into and protruding from borehole 113, and adhesive 112 fixing the protruding ends of fiber roving 111 to the other member, in this case support member 89. Anchor 110 is typical of retrofitted seismic reinforcement to an existing structure that does not lend itself to being encapsulated in panels 101 such as depicted in FIG. 3. An example of a structure that can be reinforced with anchor 110 is stadium seating that was originally designed with a beam 87 that rested upon support member 89 and was intended to be held in position by the weight of beam 87 and friction between the mating surfaces of beam 87 and support member 89. Beam 87 may have chairs attached along its length or persons may sit directly upon beam 87. Anchor 110 provides positive attachment that will resist lateral forces such as from earthquake, high wind, or explosion

Returning to FIGS. 1 and 2, insulation layer 20 is preferably formed by spray application of a water-based slurry including mineral particles 24. Several types of mineral insulation that can be sprayed as a slurry are available commercially, such as a Type 5 or Type 7 product from Southwest Vermiculite Co., Inc. Type 5, a mixture of vermiculite and gypsum, is currently the preferred formulation for use according to the method of this invention. Vermiculite and gypsum are both minerals that include water in their crystal structure. Upon being heated to high temperatures, both minerals give off the “water of crystallization” and form a different crystal structure.

The vermiculite/gypsum mixture 26 is preferably deposited onto structural member 85 by spraying a water-based slurry. Vermiculite/gypsum mixture 26 preferably includes a binder to improve the cohesive strength of deposited vermiculite/gypsum mixture 26, such as an aluminosilicate-based material of the type known as a “geopolymer.” Various ratios of vermiculite to gypsum may be used and other components may be added. Geopolymer is non-flammable.

In this specification and in the claims, “vermiculite/gypsum mixture” should be read and understood as a mixture mainly consisting of vermiculite and gypsum, and possibly including other components, such as a geopolymer material or other binder, or coconut husk or other fibers.

Vermiculite/gypsum mixture 26 is typically sprayed to a thickness of 0.5 to 3.0 inches.

It is not required that insulation layer 20 be spray applied. Insulation layer 26 may alternatively be applied by a trowel, a roller, or other suitable means. Applying insulation layer 26 with a trowel is preferred when protecting a relatively small structure 80.

Conventionally, a sprayed fireproofing slurry is allowed to dry until substantially all free moisture evaporates. Often, fans and portable heaters are brought into a structure to aid the evaporation. The portion of the structure that has been fire-proofed may be closed to workers or occupants of the building during the evaporation process because the exposed sprayed fire-proofing slurry is soft and can be damaged by contact. Closure of a portion of an occupied building is very inconvenient to occupants, which is a drawback of this procedure. Also, the relatively long evaporation time adds to the cost of construction of a new building. Drying time is typically 28 days.

According to the present invention, the free moisture is not allowed to completely evaporate from vermiculite/gypsum mixture 26. The surface of vermiculite/gypsum mixture 26 is preferably smoothed, such as with a trowel, soon after spraying is completed.

To stop evaporation of free moisture, diffusion barrier 40 is applied over smoothed vermiculite/gypsum mixture 26. Diffusion barrier 40 is preferably applied over vermiculite/gypsum mixture 26 within 1 to 3 days after vermiculite/gypsum mixture 26 has been sprayed. Vermiculite/gypsum mixture 26 contains 30 to 50% free moisture during this time range. Diffusion barrier 40 must be applied before the free moisture reaches a minimum of 20%. Vermiculite/gypsum mixture 26 can absorb more than its own weight in water without dripping or puddling.

To enhance the effectiveness of fire protection coating 10, diffusion barrier 40 is preferably A layer of a sprayable artificial stone formulation. By “artificial stone formulation” is meant a slurry of minute particles of stone, such as granite, or ceramic, such as porcelain, or mineral, such as sand; in a fluid vehicle, such as acrylic resin in an aqueous solvent. After application, the aqueous liquid evaporates and leaves a hardened residue of acrylic binder to bind the particles into a rigid coating. A suitable artificial stone formulation must be able to withstand a four-hour fire rating test without generation of smoke.

Diffusion barrier 40 may alternatively comprise other types of non-combustible coatings with very low vapor transmissibility, such as intumescent paint. Diffusion barrier 40 may alternatively include a non-fluid layer, such as a sheet of the material usually known as “bubble-wrap” previously coated with an epoxy, ceramic, or other suitable non-combustible coating; or of textile material, such as woven or knitted fabric, impregnated with a non-combustible liquid with low vapor transmissibility when cured.

Artificial stone formulation 44 is typically applied with a sprayer or roller, as is paint, but could be applied by other suitable means as are obvious to one skilled in the art. A coating thickness of 0.005 to 0.05 inches of artificial stone formulation 44 has been found to be very effective when used according to the method of the present invention. If the surface of vermiculite/gypsum mixture 26 is not smoothed before application of artificial stone formulation 44, a larger volume of artificial stone formulation 44 is required to cover vermiculite/gypsum mixture 26 to a sufficient minimum thickness, thus increasing the cost of fire protection coating 10.

Artificial stone formulation 44 also acts as a finish coat that protects underlying layers from environmental forces, such as UV light, chemicals, and provides an attractive smooth surface to fire protective coating 10.

Commercially available vermiculite/gypsum mixtures 26 generally adhere well to fiber/resin composite reinforcing materials, Such as fiberglass/epoxy panel 101 or fiber roving anchor 110 and to exposed concrete. When fire protection coating 10 according to the method of the present invention is applied to steel or other metal structural members 85, exposed steel or other metal surfaces are preferably prepared with a coat of a standard corrosion-protection primer, as is well known in the art, to prevent the free moisture of fire protection coating 10 from accelerating corrosion of the steel or other metal.

In the event of a fire, vermiculite/gypsum mixture 26 acts as a thermal insulator and slows the heating of the underlying structural member 85. Free moisture remaining from application of coating 10 consumes heat when it is evaporated to vapor. If the temperature should rise to about 180° C., water of crystallization is released from the crystals of vermiculite/gypsum mixture 26. This rearrangement phase change uses heat energy and releases more yet moisture for vaporization. Vermiculite/gypsum mixture 26 can continue to release cooling moisture up to a temperature as high as 900° C., depending upon the rate of heating.

In conventional use of vermiculite/gypsum mixture 26, time and ventilation fans are used to drive out all free moisture before any optional top coating is applied. Water of crystallization is the only available moisture in a fire. Because a non-permeable, non-flammable top layer is not typically used, even that moisture is dissipated instantly by the strong air currents of a fire.

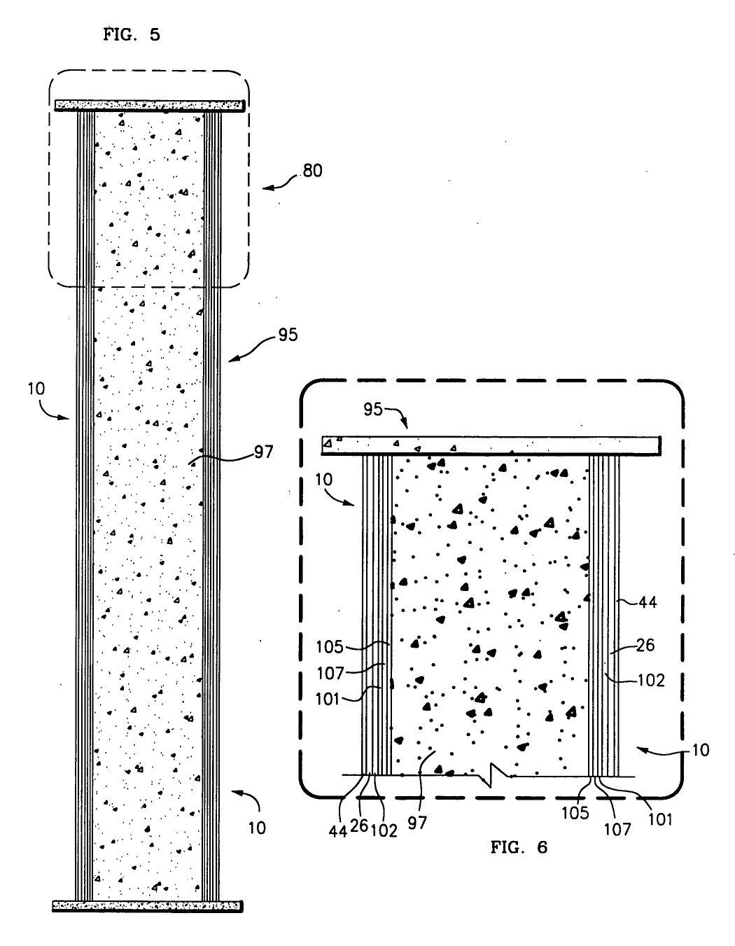

FIG. 5 is a side section view of an alternative preferred embodiment 10A of fire protective coating 10 over a concrete column 95. FIG. 6 is an enlarged side section view, partly cut away, of column 95 and fire protective coating 10A of FIG. 5. Column 95 includes concrete 97, and fiberglass/epoxy reinforcing panels 101. Column 95 may also include steel reinforcing rods (not shown).

For optimal adhesion to the vertical surface of column 95, fire protective coating 10A includes adhesion primer 105, such as a paint-like primer 106 that contains fumed silica. Fumed silica is a solid silicon oxide produced using gas-phase reactions. Primer 106 thus bonds well to both fiberglass/epoxy reinforcing panels 101 and vermiculite/gypsum mixture 26 by mechanical and chemical forces. Fire protective coating 10A also includes a support grid 102 for increased mechanical attachment of coating 10A to column 95. Support grid 102 may be a section of expanded-metal mesh 103, such as of steel or aluminum metal, or a specially-manufactured grid of a lightweight composite material, such as fiberglass reinforced epoxy (not shown), or other suitable material. The composite grid may be flat, yet flexible enough to conform to most surfaces, or it may be manufactured in modular shapes that will cover typical curves or other shapes without having to be bent.

Column 95 may be a structural member 85 of a structure 80 such as a parking garage, in which column 95 may be subject to being bumped by vehicles or repeated contact with persons. Vermiculite/gypsum mixture 26 is relatively soft and cork-like. Even when protected by diffusion barrier 40, vermiculite/gypsum mixture 26 can be dented or scraped away by forceful impact or deliberate vandalism. For additional mechanical strengthening in an environment such as a parking garage, mechanical strengthening in the form of a sheet of textile material saturated with artificial stone formulation 42. The saturated sheet is flexible enough to be wrapped around column 95 and helps toughen the surface of artificial stone formulation 42.

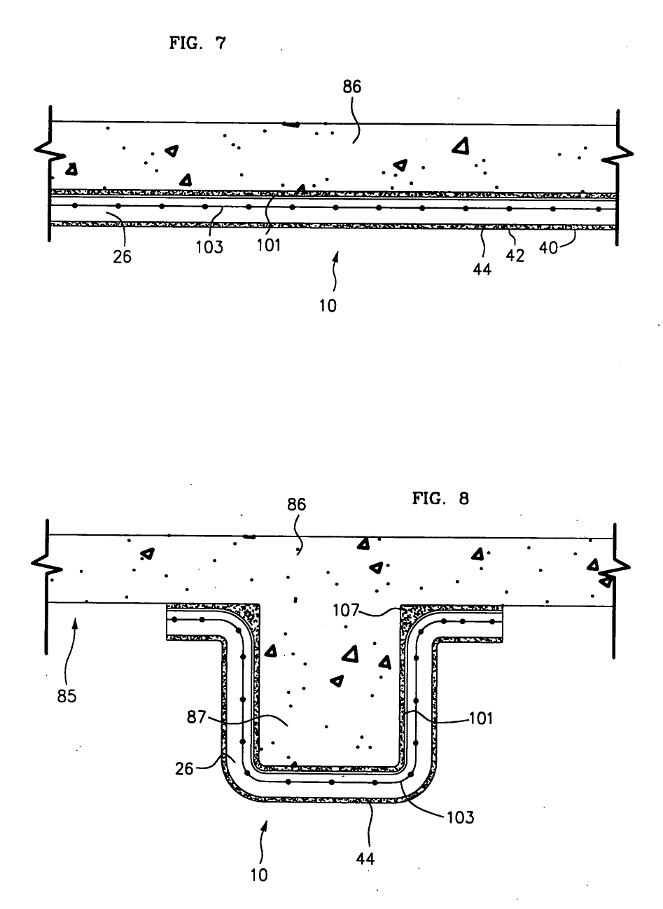

FIG. 7 is a sectional view, partly cut away, of fire protective coating 10 on a concrete floor deck 86 reinforced with composite panel 101. FIG. 8 is a sectional view, partly cut away, of a concrete beam 87 reinforced with composite panel 101. As best seen in FIG. 8, composite panel 101 is attached to beam 87 by a layer of adhesive 107, which also fills internal corners, such as where beam 87 meets floor deck 86.

From the foregoing description, it is seen that fire protection coating 10, applied according to the method of the present invention, provides an effective fire rating at lower total thickness than conventional fire protection coatings. Fire protection coating 10 of the present invention is especially compatible with structures that include fiber/resin seismic reinforcement and serves to prolong the time before combustion of the reinforcement panels or anchors, decreasing the restoration work that would be needed after a fire. Fire protection coating 10 is also effective at slowing the temperature increase of steel or concrete structural members, providing more time for evacuation of the structure and for fire-fighting efforts before collapse or major structural damage to the structural members.

Although particular embodiments of the invention have been illustrated and described, various changes may be made in the form, composition, construction, and arrangement of the parts herein without sacrificing any of its advantages. Therefore, it is to be understood that all matter herein is to be interpreted as illustrative and not in any limiting sense, and it is intended to cover in the appended claims such modifications as come within the true spirit and scope of the invention.

I claim:

1. In combination:
a structural member of a structure; and
a fire protection coating attached to said structural member; including:
a moist insulation layer containing free moisture; and
a diffusion barrier covering said moist insulation layer, for preventing loss of free moisture from said moist insulation layer.

2. The combination of claim 1, wherein said structural member is of steel.

3. The combination of claim 1, wherein said structural member is of concrete.

4. The combination of claim 1, wherein said structural member is of aluminum.

5. The combination of claim 1, wherein said structural member is reinforced with a fiber/resin composite material.

6. The combination of claim 5, said fiber/resin composite material including an anchor element including a length of fiber roving embedded in polymer.

7. The combination of claim 1, said insulation layer comprising:
a paste containing water and mineral particles.

8. The combination of claim 7, said mineral particles comprising particles of one or more minerals that include water in the crystal structure that is driven out by the heat of a fire.

9. The combination of claim 1, said diffusion barrier including:
an artificial stone formulation.

10. The combination of claim 9 said water-containing paste of mineral particles including a mixture of vermiculite and gypsum particles capable of being applied by spray coating.

11. The combination of claim 5, said fire protection coating further including:
an adhesion primer applied to the outer surface of said fiber/resin composite material to promote adhesion between said fiber/resin composite material and said insulation layer.

12. The combination of claim 1, said diffusion barrier including:
a sheet of textile material impregnated with an artificial stone formulation.

13. A fire protection coating for structural members including:
a moisture-containing insulation layer attached to a structural member; and
a diffusion barrier layer covering said moisture-containing insulation layer to prevent loss of moisture from said insulation layer.

14. The fire protection coating of claim 13, said moisture-containing insulation layer comprising:
a paste including water and mineral particles.

15. The fire protection coating of claim 14, said mineral particles comprising one from the group: vermiculite, gypsum, perlite, or a blend of vermiculite and gypsum.

16. The fire protection coating of claim 14, said insulation layer being formed from a sprayed-on slurry including mineral particles.

17. The fire protection coating of claim 14, said diffusion barrier being a layer of an artificial stone formulation.

18. The fire protection coating of claim 17, said artificial stone formulation being applied in a layer 0.005 to 0.25 inch thick.

19. The fire protection coating of claim 17, said artificial stone formulation including an aqueous solvent.

20. The fire protection coating of claim 16, said slurry being sprayed onto the structural member 0.125 to 4.0 inches thick.

21. The fire protection coating of claim 13, said diffusion barrier layer including:
a sheet of textile material impregnated with an artificial stone formulation.

22. The fire protection coating of claim 13, further including:
a support grid attached to the outer surface of the structural member for promoting attachment of said fire protection coating to the structural member.

23. The fire protection coating of claim 13, further including:
an adhesion primer applied to the outer surface of the structural member for promoting attachment of said fire protection coating to the structural member.

24. The fire protection coating of claim 14, the mineral particles comprising particles of one or more minerals that include water in the crystal structure.
